(19) United States
(12) Patent Application Publication
(10) Pub. No.: US 2021/0171033 A1
(43) Pub. Date: Jun. 10, 2021

(54) CONTROLLER AND METHOD FOR ACTIVATING ADAPTIVE CRUISE CONTROL

(71) Applicant: Bendix Commercial Vehicle Systems LLC, Elyria, OH (US)

(72) Inventors: Andrew J. Pilkington, Avon Lake, OH (US); Rohan N. Nachnolkar, Elyria, OH (US); Mathew J. John, Avon, OH (US)

(21) Appl. No.: 16/706,982

(22) Filed: Dec. 9, 2019

(51) Int. Cl. B60W 30/165; B60W 50/08; B60W 40/09

(52) U.S. Cl. CPC B60W 30/165; B60W 40/09; B60W 50/082

(57) ABSTRACT

A controller and method for activating adaptive cruise control systems are presented. The controller includes an input for receiving a speed of the host vehicle and a processor having control logic. The control logic determines the system is inactive, determines if the vehicle speed is at or above a minimum speed, determines if a predetermined time has passed and activates adaptive cruise control without a driver intervention.

### BACKGROUND

The present invention relates to embodiments of a system, controller and method for enabling adaptive cruise control (ACC). ACC for commercial vehicles includes many advantages regarding safety and fuel economy, however some drivers still do not activate ACC during normal long distance or daily driving situations. There is a need to improve how ACC is accepted by the drivers and enabled.

### SUMMARY

Various embodiments of a controller for an adaptive cruise control system are presented. The controller includes an input for receiving a speed of the host vehicle and a processor having control logic. The control logic determines the system is inactive, determines if the vehicle speed is at or above a minimum speed, determines if a predetermined time has passed and then activates adaptive cruise control without a driver intervention.

In accordance with another aspect, various methods of activating adaptive cruise control are presented. One method comprises determining ACC is inactive, receiving a speed of the host vehicle, determining that the speed is at or above a minimum speed, determining that a predetermined amount of time has passed and activating ACC without driver intervention.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a vehicle system having adaptive cruise control according to one example of the present invention.

FIG. 2 illustrates a method to enable adaptive cruise control according to one example of the present invention.

### DETAILED DESCRIPTION

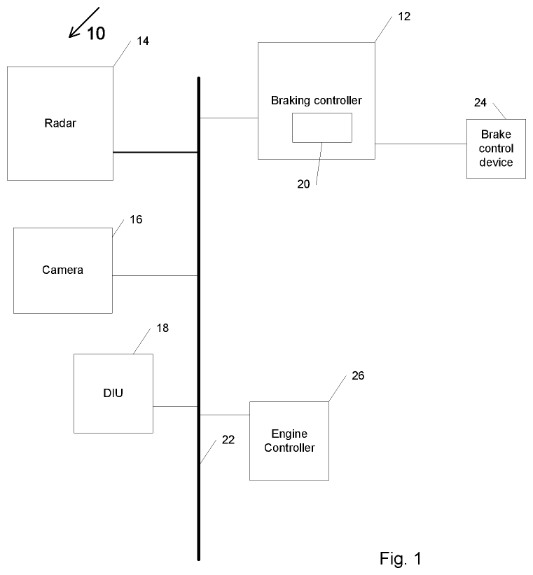

FIG. 1 illustrates a vehicle system 10 for a commercial vehicle. The system 10 includes at least one camera 16. The camera 16 may be a forward looking camera for viewing and analyzing the area in front of the vehicle. The video signals of camera 16 may be analyzed to detect an object's presence, size, longitudinal distance and lateral distance with respect to the vehicle. The camera 16 can detect, via image signal interpretation, multiple stationary or moving objects within a wide range to the front, side and rear of the vehicle.

The vehicle system 10 includes at least one radar 14, which can be a forward radar. The radar 14 transmits and receives radar signals, which are electromagnetic waves used to detect an object's presence, longitudinal distance, lateral distance, speed and direction with respect to the vehicle. The radar 14 can detect multiple stationary or moving objects within a wide range to the front and sides of the vehicle. The radar 14 is used to determine the steady-state longitudinal distance so that the adaptive cruise control system can maintain that distance with a target vehicle. The information from the radar 14 is used in requesting engine, retarder and brake torque control accordingly.

The vehicle system 10 includes at least one brake control device 24. The at least one brake control device 24 is responsive to control signals to affect braking of the vehicle.

The vehicle system 10 includes a driver information device 18. The driver information device 18 may be a warning lamp, an audible system or may be a display device that communicates additional information to the driver about the status of the vehicle functions. The driver information device 18 may also include a switch or touchscreen input for the driver to enable or disable functions of the vehicle, including the adaptive cruise control function.

The vehicle system 10 includes an engine with engine controller 26. The engine controller 26 governs the speed of the vehicle. The engine controller 26 may include preset conditions for engaging cruise control, for example, minimum vehicle speed, maximum vehicle speed, cruise control governing speed, override capabilities and cruise control cancelation requirements.

The vehicle system 10 includes a communications bus 22, which may use J1939 CAN or other protocol. Each of the devices of the vehicle system 10 may be connected to the communications bus 22.

The vehicle system 10 includes a braking system controller 12. The braking system controller 12 can perform adaptive cruise control (ACC), stability control and antilock braking functions. The controller 12 includes a communications port for communicating with the communication bus 22. The controller 12 includes inputs for receiving the signals from the camera 16 and the radar 14 or the controller 12 may receive the camera and radar signals via the communication bus 22. The controller 12 may directly control the driver information device 18 or may transmit control signals and other information via the communication bus 22. Information transmitted to the driver information device 18 may include whether ACC is active and alerts regarding following distance. The controller 12 may directly control the at least one brake control device 24.

The controller 12 includes a processor with control logic 20 for interpreting signals from devices installed on the vehicle, both directly and through the communications bus 22. The control logic 20 communicates with a memory, which may include volatile memory, non-volatile memory, solid state memory, flash memory, random-access memory (RAM), read-only memory (ROM), electronic erasable programmable read-only memory (EEPROM), variants of the foregoing memory types, combinations thereof, and/or any other type(s) of memory suitable for providing the described functionality and/or storing computer-executable instructions for execution by the control logic 20. The control logic 20 also includes a timer function.

The control logic 20 analyzes the information received from the camera 16, radar 14 and other sensors on the vehicle to determine if automated driving, such as lane-keeping and adaptive cruise control, can be initiated and maintained. Vehicle environment signals can include weather, time of day, presence of sun glare, curvature of the road and incline of the road. In general, the vehicle environment signals, as well as the camera and radar signals, must meet a minimum quality requirement in order to maintain the automated driving mode. Other information known by the control logic 20 includes whether anti-lock braking, stability control or yaw control is active. The control logic 20 also receives the vehicle speed from wheel speed sensors or another controller, such as the engine controller 26, on the communications bus 22. The control logic 20 may control the automated driving actions of the vehicle by transmitting signals to a steering control component, engine controller 26 and the at least one brake control device 24. The control logic 20 may communicate the vehicle sensor signals via the communications bus 22 for other vehicle systems to use in their decision-making process.

Therefore, a controller for an adaptive cruise control system in a host vehicle comprises an input for receiving a speed of the host vehicle and a processor having control logic. The control logic determines the system is inactive, determines if the vehicle speed is at or above a minimum speed and determines if a predetermined time has passed.

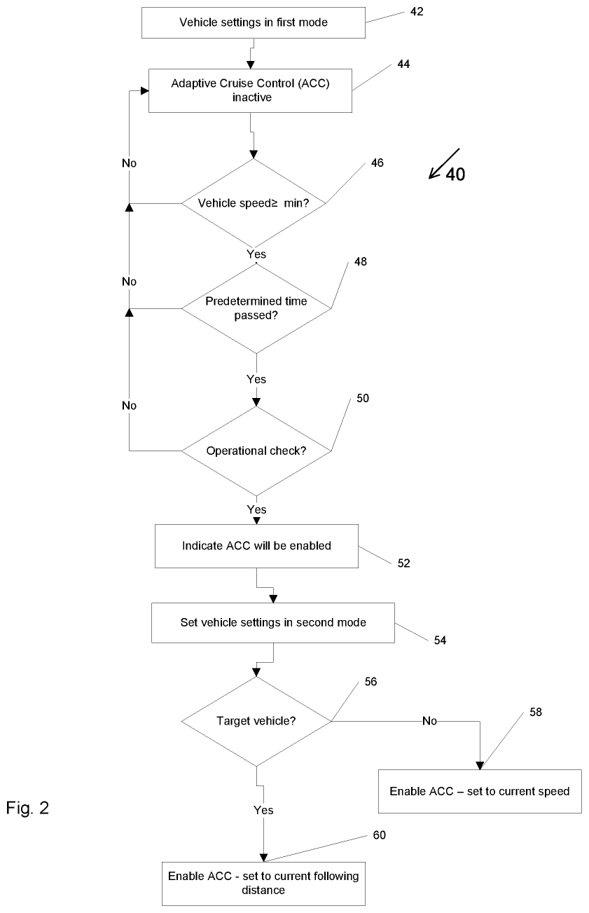

FIG. 2 illustrates a method 40 to activate adaptive cruise control (ACC) according to one example of this invention. Method 40 begins with step 42. In step 42, the vehicle settings, such as following distance and maximum vehicle speed, are in a first mode. The first mode may be a default set by the equipment manufacturer or the vehicle owner. Other preset vehicle settings are contemplated. A following distance alert may be preset to activate when the following distance between the host vehicle and a target vehicle in the first mode is between about 3.2 seconds and 3.7 seconds. In another example, the following distance alerts will be activated at a following distance of 3.5 seconds. In addition, the vehicle can be governed by the engine controller 26 so as not to exceed a maximum speed regardless of the driver throttle input. A maximum vehicle speed for the first mode may be preset between about 55 miles per hour and 62 miles per hour.

In step 44, the ACC is not active. This state may be simply due to the default state of ACC being not active upon power up of the vehicle or due to the driver not enabling the ACC through the driver information device 18. However, following distance alerts will still be given to the driver via the driver information device 18 if the vehicle breaches the preset following distance.

In step 46, the control logic 20 receives the vehicle speed. The vehicle speed is compared against a minimum speed. The minimum speed may be about 37 mph. The minimum speed can be set between 16 mph and 45 mph. The minimum speed can be set by the equipment manufacturer in the control logic 20 or can be programmed by the vehicle owner. If the vehicle speed is at or above the minimum speed, the method 40 continues to step 48. If the vehicle speed is lower than the minimum speed, the method 40 returns to step 44 and ACC remains inactive.

In step 48, the control logic 20 determines if a predetermined amount of time has passed since the vehicle has been above the minimum speed as determined in step 46. In one example, the predetermined amount of time is about three minutes. The predetermined amount of time can be between two minutes and five minutes. In another embodiment, the predetermined time can be programmed in the control logic 20 by the equipment manufacturer or the vehicle owner. If the predetermined time has not passed, the method 40 returns to step 44 and ACC remains inactive. If the predetermined amount of time has passed, the method 40 continues to step 50.

In step 50, additional checks of the vehicle operation and location are made to ensure that ACC can be enabled. In one example, the control logic 20 determines the driver is seated by checking the seatbelt latch. In another example, the information from the camera 16 and radar 14 can be reviewed to ensure there are no upcoming stationary obstacles that would require braking intervention. In another example, the vehicle environment signals are checked to ensure that the weather is conducive to automated driving actions, for example. In another example, the vehicle location can be cross referenced by a database to confirm that the vehicle is on an interstate or highway conducive to ACC operation. If these operational checks are not passed, the method 40 returns to step 44 and ACC remains inactive. If the operational checks are passed, the method 40 continues to step 52.

In step 52, the control logic 20 indicates to the driver via the driver information device 18 that ACC will be enabled.

In one example of the present invention, the driver will be given another period of time in which to manually indicate that he does not want ACC enabled. He will indicate his decision through the driver information device 18. His decision to keep ACC inactive will be recorded by the control logic 20.

In step 54, the control logic 20 will set the vehicle settings in a second mode. Vehicle settings in the second mode may include transmitting a signal to the engine controller 26 to request an increase in the maximum governed vehicle cruise control speed. In one example, the maximum speed may be set to between 65 mph and 70 mph. The second mode vehicle settings may include reducing the following distance alert to between about 2.8 seconds and 3.2 seconds. The result will be fewer following distance warnings communicated over the driver information device 18 as long as the vehicle remains outside the preset following distance.

The second mode may include settings programmed by the vehicle owner and may be preferred settings for the driver. In order to achieve the preferred settings, ACC must be enabled. This function serves as an incentive for the driver to permit ACC to be enabled automatically. The second mode will allow the driver to reduce the following distance to a target vehicle before the alerts are triggered and also travel at a higher speed during cruise control. These settings are generally preferred by drivers.

In step 56, the control logic 20 determines if there is a target vehicle ahead of the host vehicle. If there is no target vehicle, ACC is enabled automatically in step 58 with the current vehicle speed, which can be up to the second mode maximum vehicle speed.

If there is a target vehicle detected in step 60, ACC is automatically enabled and the current following distance is set as the desired following distance. The desired following distance will not breach the second mode minimum following distance. ACC will remain enabled until an event that normally disables the ACC occurs, such as the driver depressing the brake pedal.

Therefore, a method of activating adaptive cruise control (ACC) comprises determining ACC is inactive, receiving a speed of the host vehicle, determining that the speed is at or above a minimum speed, determining that a predetermined amount of time has passed and activating ACC without driver intervention.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

We claim:

1. A controller for an adaptive cruise control (ACC) system in a host vehicle comprising:
an input for receiving a speed of the host vehicle;
a processor having control logic, the control logic
determining the ACC system is inactive;
determining if the vehicle speed is at or above a minimum speed;
determining if a predetermined time has passed; and
activating ACC without a driver intervention.

2. The controller as in claim 1, further comprising
an input indicative of driver presence; wherein the control logic activates ACC upon determining the driver is present in the host vehicle.

3. The controller as in claim 1, wherein the minimum speed is about 35 mph.

4. The controller as in claim 1, wherein the predetermined time is between about two and five minutes.

5. The controller as in claim 1, further comprising an input indicative of a target vehicle at an instant distance; wherein ACC is activated to follow the target vehicle at the same instant distance.

6. The controller as in claim 1, further comprising an output for indicating to the driver that ACC will be activated.

7. The controller as in claim 6, further comprising an input for the driver to disable ACC after receiving the indication that ACC will be activated.

8. The controller as in claim 1, wherein the control logic changes a set of host vehicle limits in response to activating the ACC.

9. A method for activating adaptive cruise control (ACC) comprising:
determining ACC is inactive;
receiving a speed of the host vehicle;
determining that the speed is at or above a minimum speed;
determining that a predetermined amount of time has passed; and
activating ACC without driver intervention.

10. The method as in claim 9, further comprising
receiving an indication of driver presence; and
activating ACC upon determining the driver is present in the host vehicle.

11. The method as in claim 9, wherein the minimum speed is about 35 mph.

12. The method as in claim 9, wherein the predetermined time is between about two and five minutes.

13. The method as in claim 9, further comprising
receiving an indication of a target vehicle at an instant distance; and
activating ACC to follow the target vehicle at the same instant distance.

14. The method as in claim 9, further comprising: indicating to the driver that ACC is active.

15. The method as in claim 9, further comprising changing a set of host vehicle limits in response to activating the ACC.
